(19) United States
(12) Patent Application Publication
(10) Pub. No.: US 2026/0194460 A1
(43) Pub. Date: Jul. 9, 2026

(54) TERAHERTZ WAVE REFLECTION OPTICAL SYSTEM MODULE

(71) Applicant: MINDSEYE CO., LTD., Gyeonggi-do (KR)

(72) Inventor: Ji Joong HONG, Gyeonggi-do (KR)

(21) Appl. No.: 19/131,927

(22) PCT Filed: Nov. 22, 2022
(86) PCT No.: PCT/KR2022/018498

§ 371 Date: May 21, 2025

(51) Int. Cl. G01N 21/3586; G01N 21/01; G01N 21/55

(52) U.S. Cl. CPC G01N 21/3586; G01N 21/01; G01N 21/55; G01N 2021/0112

(57) ABSTRACT

The present invention relates to a terahertz wave reflection optical system module for irradiating a sample with terahertz waves and detecting terahertz waves reflected from the sample, the module comprising: a mirror block having mounted thereon a plurality of parabolic mirrors that constitute a sample irradiation optical system and a sample reflection optical system; an emitter mounting part which is position-adjustably coupled to one side of the rear of the mirror block and has an emitter mounted thereon; a detector mounting part which is position-adjustably coupled to the other side of the rear of the mirror block and has a detector mounted thereon; and a visible laser unit coupled to a side surface of the mirror block.

### TECHNICAL FIELD

The present invention relates to a terahertz wave reflection optical system, and more specifically, to a compact reflection optical system module including a terahertz wave generator.

### BACKGROUND ART

Terahertz waves are electromagnetic waves having terahertz-level frequencies in the range of 1012 to 1014 Hz, which lie between infrared and microwave, and have a characteristic that the amount of transmission and reflection varies depending on the electrical properties of an object. Terahertz waves have the advantage of being able to penetrate opaque samples through which visible light cannot pass, and having a shorter wavelength than microwaves, resulting in higher resolution. Due to these properties, their use is increasingly expanding in various fields such as semiconductor material properties and multilayer film measurement, coating thickness measurement, defect detection, and bio-medicine.

A terahertz wave measurement device generally includes a terahertz wave generation unit, a first optical system for irradiating a sample with terahertz waves generated from the terahertz wave generation unit, a second optical system for guiding terahertz waves reflected from the sample to a detector, a detector for detecting the reflected terahertz waves, and a computing device for processing detector signals.

Terahertz waves are generated by optical rectification in a photoconductor that reacts to a femtosecond pulse laser. Specifically, terahertz wave pulses are generated when a femtosecond pulse laser is irradiated onto a terahertz emitter including a PCA (photoconductive antenna).

FIG. 1 is a plan view illustrating a layout of a terahertz wave optical system. Referring to FIG. 1, a femtosecond pulse laser emitted from the femtosecond pulse light source is split by a beam splitter after passing through a wavelength converter and a filter. One part (Beam 1) is irradiated onto a terahertz emitter (THz emitter) after passing through a scan delay stage, functioning as a pump beam for terahertz wave pulse generation. The other part (Beam 2) is guided to a detector and functions as a probe beam. The terahertz wave (THz) generated from the terahertz emitter by the femtosecond pulse is focused by a first optical system (PM1, PM2) and irradiated onto a specific position of the sample. After being reflected from the sample, it is focused onto a detector (Detector Antenna) by a second optical system (PM3, PM4), and the intensity of the reflected light is detected. The probe beam reaches the detector earlier than the terahertz wave reflected by the sample and serves to set a reference time point for the terahertz wave detection.

Such a terahertz wave optical system has a complex configuration in which a femtosecond laser light source, a delay stage, and optical systems are arranged on a table, and an emitter, a detector antenna, and parabolic mirrors are placed within a chamber on the same table. In particular, the conventional terahertz wave optical system (10) occupies a large space within the optical chamber, including the emitter and detector antenna configuration and parabolic mirrors, resulting in poor spatial efficiency and difficulties in maintenance and optical system setup. Furthermore, it has been difficult to apply such a terahertz wave optical system (10) placed in a chamber on an optical table to a robot arm or a three-dimensional gantry. This is because the terahertz wave optical system (10) installed in the chamber not only occupies a large space but also has a structure in which optical alignment is difficult to maintain. Therefore, as shown in FIG. 1, it can be applied to measure the material properties of a prepared sample, but it is difficult to couple it to a transfer means such as a robot arm.

(Patent Document) Korean Patent Publication No. 10-1788450

### DISCLOSURE

### Technical Problem

The present invention is directed to solve the above-mentioned problems and to provide a compact terahertz wave reflection optical system module with improved spatial efficiency.

The present invention also aims to provide a terahertz reflection optical system module that allows for efficient and simple tuning and is easily applicable to various application devices such as robot arms.

The present invention further aims to provide a compact terahertz wave reflection optical system module that allows for easy confirmation of the irradiation position of terahertz waves.

### Technical Solution

To solve said problems, a terahertz wave reflection optical system module according to one aspect of the present invention is disclosed. The terahertz wave reflection optical system module according to an aspect of the present invention is for irradiating a sample with terahertz waves and detecting terahertz waves reflected from the sample, and includes: a mirror block on which a plurality of parabolic mirrors constituting a sample irradiation optical system and a sample reflection optical system are mounted; an emitter mounting part position-adjustably coupled to one side of the rear of the mirror block for mounting an emitter; and a detector mounting part position-adjustably coupled to the other side of the rear of the mirror block for mounting a detector. The terahertz wave reflection optical system module is compact and can be mounted on a driving unit such as a robot arm.

It is preferable that the mirror block has a rectangular frame shape with front and rear openings and a space formed therein for mounting the plurality of parabolic mirrors, and the emitter mounting part and the detector mounting part are arranged side by side at the rear of the mirror block.

The sample irradiation optical system including first and second parabolic mirrors is arranged at one side inside the mirror block so as to be aligned with the emitter mounting part, the first parabolic mirror is fixed to the lower part of the mirror block, and the second parabolic mirror fixed to the upper part of the mirror block is disposed to face the upper side of the first parabolic mirror.

The sample reflection optical system including third and fourth parabolic mirrors is arranged at the other side inside the mirror block so as to be aligned with the detector mounting part, the third parabolic mirror is fixed to the upper part of the mirror block, and the fourth parabolic mirror fixed to the lower part of the mirror block is disposed to face the lower side of the third parabolic mirror.

The sample irradiation optical system is configured such that terahertz waves generated from the emitter and irradiated forward are upwardly collimated by the first parabolic mirror and irradiated to the second parabolic mirror, and the upwardly collimated terahertz waves are focused at a predetermined position in front by the second parabolic mirror. The predetermined position is a measurement area of the sample where terahertz waves are focused and reflected.

The sample reflection optical system is configured such that terahertz waves reflected from the predetermined focused position are irradiated to the third parabolic mirror, downwardly collimated by the third parabolic mirror and irradiated to the fourth parabolic mirror, and focused by the fourth parabolic mirror to be detected by the detector mounted on the detector mounting part.

According to another aspect of the present invention, the mirror block has a space formed therein for mounting the plurality of parabolic mirrors. The sample irradiation optical system includes first and second parabolic mirrors disposed to face each other vertically, and the first parabolic mirror fixed to one side inside the mirror block so as to be aligned with the emitter is fixed to the lower part of the mirror block to upwardly collimate terahertz waves irradiated forward from the emitter.

The second parabolic mirror fixed to the upper part of the mirror block is disposed to focus the vertically collimated terahertz waves at a predetermined position in front. The sample reflection optical system includes third and fourth parabolic mirrors disposed vertically. The third parabolic mirror is fixed to the upper part of the mirror block adjacent to the second parabolic mirror and disposed to downwardly collimate terahertz waves irradiated from the predetermined position.

The fourth parabolic mirror fixed to the lower part of the mirror block is disposed to focus the downwardly collimated terahertz waves rearward to be transmitted to the detector.

According to an aspect of the present invention, the terahertz wave reflection optical system module further includes a first transfer unit connecting the emitter mounting part to the mirror block so as to be movable in the xy-axis direction, and a second transfer unit connecting the detector mounting part to the mirror block so as to be movable in the xy-axis direction.

The emitter mounting part includes an emitter holder supporting and receiving the emitter, a first pusher hinge-coupled to the emitter holder for fixing the emitter to the emitter holder, and a first spring assembly providing a fixing force to the first pusher.

The detector mounting part includes a detector holder supporting and receiving the detector, a second pusher hinge-coupled to the detector holder for fixing the detector to the detector holder, and a second spring assembly providing a fixing force to the second pusher.

The xy-axis direction is the horizontal and vertical direction in the rear surface of the mirror block.

The first transfer unit includes a first X-axis transfer unit configured to allow translational movement in the X-axis direction with respect to the mirror block and a first Y-axis transfer unit configured to allow translational movement in the Y-axis direction. The first X-axis transfer unit includes a first X-axis fixing screw for fixing the position of the first X-axis transfer unit and a first X-axis adjustment screw for finely adjusting the X-axis direction position of the first X-axis transfer unit, and the first Y-axis transfer unit includes a first Y-axis fixing screw for fixing the first Y-axis transfer unit and a first Y-axis adjustment screw for finely adjusting the Y-axis direction position of the first Y-axis transfer unit.

The second transfer unit includes a second X-axis transfer unit configured to allow translational movement in the X-axis direction with respect to the mirror block and a second Y-axis transfer unit configured to allow translational movement in the Y-axis direction. The second X-axis transfer unit includes a second X-axis fixing screw for fixing the position of the second X-axis transfer unit and a second X-axis adjustment screw for finely adjusting the X-axis direction position of the second X-axis transfer unit, and the second Y-axis transfer unit includes a second Y-axis fixing screw for fixing the second Y-axis transfer unit and a second Y-axis adjustment screw for finely adjusting the Y-axis direction position of the second Y-axis transfer unit.

The terahertz wave reflection optical system module may further include a connection plate fixed to the lower or upper part of the mirror block, and the connection plate may have a fastening part for coupling to a robot arm or a transfer device.

The terahertz wave reflection optical system module may further include a visible light laser unit coupled to a side surface of the mirror block.

The visible light laser unit includes a pair of visible light laser units (500) respectively coupled to both side surfaces of the mirror block.

Each visible light laser unit is equipped with an adjustment screw capable of adjusting the attitude of the visible light laser (510) so that the visible light laser beam irradiated therefrom coincides with the terahertz wave irradiation position of the sample. The pair of visible light laser units are irradiated so as to correspond to the focused position of terahertz waves by the sample irradiation optical system, thereby enabling visual monitoring of the terahertz wave irradiation position while irradiating excitation light to the sample.

The sample irradiation optical system and the sample reflection optical system are adjacently arranged side by side within the mirror block. The sample irradiation optical system is composed of first and second parabolic mirrors mounted to face each other vertically on the upper and lower sides of the mirror block, and the sample reflection optical system is composed of third and fourth parabolic mirrors mounted to face each other vertically on the upper and lower sides of the mirror block.

The sample irradiation optical system implements an optical path in which terahertz waves are vertically collimated from the rear of the mirror block via the first parabolic mirror and focused forward by the second parabolic mirror, and the sample reflection optical system implements an optical path in which terahertz waves are vertically collimated from the front of the mirror block via the third parabolic mirror and focused rearward by the fourth parabolic mirror.

Terahertz waves reflected from the focused position by the sample irradiation optical system are arranged to enter the third parabolic mirror of the sample reflection optical system.

The first parabolic mirror and the fourth parabolic mirror are arranged side by side in the left-right direction and have the same focal length, and the second parabolic mirror and the third parabolic mirror are arranged side by side in the left-right direction and have the same focal length. Preferably, the focal length of the second parabolic mirror is greater than the focal length of the first parabolic mirror.

### Advantageous Effects

According to an aspect of the present invention, a compact terahertz wave reflection optical system module that can be mounted on the head of a three-dimensional transfer mechanism such as a robot arm is provided.

According to another aspect of the present invention, a terahertz reflection optical system module that allows for efficient and simple tuning is provided.

According to another aspect of the present invention, a compact terahertz wave reflection optical system module capable of easily monitoring the irradiation position of terahertz waves and a setting method using the same are provided.

### DESCRIPTION OF DRAWINGS

FIG. 1 is a plan view illustrating a layout of a terahertz wave optical system.

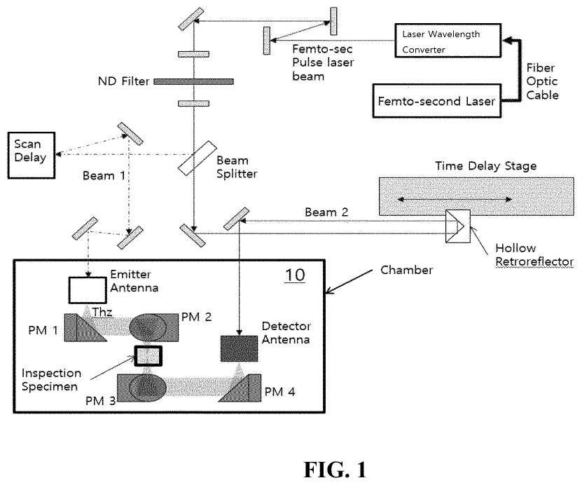

FIG. 2 is a perspective view of a terahertz wave reflection optical system module according to one embodiment of the present invention.

FIG. 3 is a front perspective view of a terahertz wave reflection optical system module according to one embodiment of the present invention.

FIG. 4 is a rear perspective view of a terahertz wave reflection optical system module according to one embodiment of the present invention.

FIG. 5 is a top view of a terahertz wave reflection optical system module according to one embodiment of the present invention.

FIG. 6 is a partially exploded rear perspective view of a terahertz wave reflection optical system module according to one embodiment of the present invention.

FIG. 7 is a rear view of a terahertz wave reflection optical system module according to an embodiment of the present invention.

FIG. 8 is a schematic diagram illustrating a state in which a terahertz wave reflection optical system module according to an embodiment of the present invention is mounted on a robot arm.

### BEST MODE MODE OF THE INVENTION

Hereinafter, embodiments of the present invention will be described in detail with reference to the accompanying drawings so that those skilled in the art to which the present invention pertains can easily carry out the invention. However, the present invention can be implemented in many different forms and is not limited to the embodiments described herein. In the drawings, parts irrelevant to the description are omitted for clarity, and like reference numerals denote like parts throughout the specification. In this process, the thicknesses of lines or the sizes of constituent elements shown in the drawings may be exaggerated for clarity and convenience of explanation.

Throughout the specification, when a part is referred to as being “connected” or “coupled” to another part, it includes not only the case where it is “directly connected” or “directly coupled” but also the case where it is “connected” or “coupled” with another constituent element interposed therebetween. In addition, when a part is described as “including” a certain constituent element, this means that it may further include other constituent elements rather than excluding other constituent elements unless specifically stated otherwise.

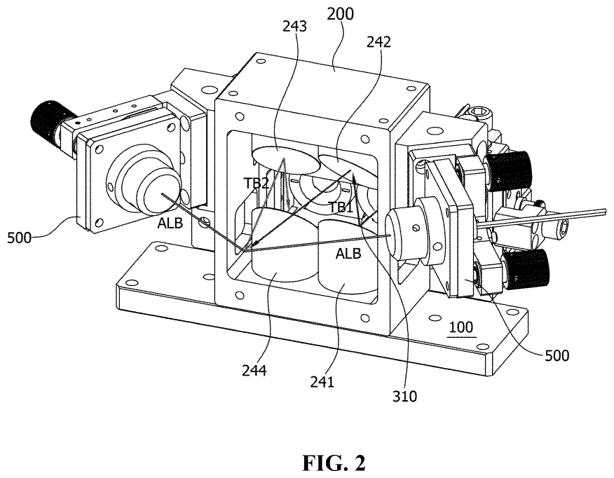

Hereinafter, preferred embodiments of the present invention will be described in detail with reference to the drawings. FIG. 2 is a perspective view of a terahertz wave reflection optical system module according to an embodiment of the present invention.

Referring to FIGS. 2 to 5, a terahertz wave reflection optical system module according to an embodiment of the present invention has a structure for irradiating a sample with terahertz waves and detecting terahertz waves reflected from the sample. The terahertz wave reflection optical system module includes a mirror block (200) on which a plurality of parabolic mirrors (241, 242, 243, 244) are mounted, a connection plate (100) fixed to the lower part of the mirror block, an emitter mounting part on which an emitter (310) is mounted, a detector mounting part on which a detector (320) is mounted, and a pair of visible light laser units (500) coupled to the side surfaces of the mirror block. The emitter mounting part is position-adjustably coupled to one side of the rear of the mirror block (200), and the detector mounting part is position-adjustably coupled to the other side of the rear of the mirror block.

A femtosecond pulse laser is transmitted to the emitter (310) mounted on the emitter mounting part by an optical fiber (311), thereby generating terahertz waves. The terahertz waves generated from the emitter are irradiated onto a sample in front by a sample irradiation optical system mounted on the front mirror block, and then the terahertz waves reflected by the sample can be transmitted to the detector by a sample reflection optical system mounted inside the mirror block (200). Probe light can be transmitted to the detector (320) by an optical fiber cable (321), and a detection signal from the detector can be transmitted to an external device by a separate cable.

At the rear of the mirror block (200), the emitter mounting part and the detector mounting part are arranged side by side so as to face each other, and a plurality of parabolic mirrors (241, 242, 243, 244) constituting the sample irradiation and reflection optical systems are arranged inside the mirror block. Preferably, the mirror block (200) has a rectangular frame shape with front and rear openings and a space formed therein for mounting the plurality of parabolic mirrors. Alternatively, the mirror block (200) is configured such that at least a portion of the front and rear is open, allowing terahertz waves to be transmitted without interruption of the optical path between the rear emitter, detector, the plurality of internal parabolic mirrors (241, 242, 243, 244), and the sample positioned in front.

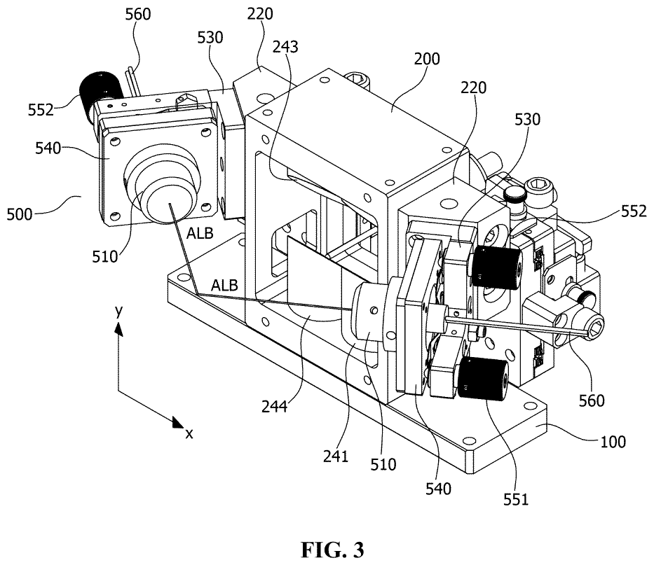

The mirror block may be compact and have a width (in the x-axis direction in FIG. 3) of 10 cm to 15 cm, a depth (in the front-rear direction) of 5 cm to 10 cm, and a height (in the y-axis direction in FIG. 3) of 5 cm to 10 cm.

The sample irradiation optical system composed of the first and second parabolic mirrors (241, 242) is arranged at one side inside the mirror block, in front of the emitter mounting part. The sample reflection optical system composed of the third and fourth parabolic mirrors (243, 244) is arranged at the other side inside the mirror block, in front of the detector mounting part. The first and second parabolic mirrors (241, 242) are disposed to face each other at the lower and upper parts, respectively, inside the mirror block, and the third and fourth parabolic mirrors (243, 244) are disposed to face each other at the upper and lower parts, respectively, adjacent to the second and first parabolic mirrors (242, 241).

The first and fourth parabolic mirrors have the same focal length, and the second and third parabolic mirrors have the same focal length. For example, the first and fourth parabolic mirrors may have a focal length of 2 inches and an outer diameter of 1 inch, and the second and third parabolic mirrors may have a focal length of 3 inches and an outer diameter of 1 inch. The sample irradiation optical system composed of the first and second parabolic mirrors and the sample reflection optical system composed of the third and fourth parabolic mirrors each implement corresponding optical paths, and are arranged such that light reflected from the focused position by the sample irradiation optical system is incident on the third parabolic mirror of the sample reflection optical system.

More specifically, the first parabolic mirror (241) fixed to the lower surface of the mirror block is arranged at one side inside the mirror block so as to be aligned with the emitter. The first parabolic mirror (241) is fixed to the lower part of the mirror block such that its mirror surface faces the rear and upper sides of the mirror block.

The first parabolic mirror fixed to the lower part of the mirror block has its mirror surface arranged to upwardly collimate terahertz waves that are forwardly and diffusely irradiated from the emitter. To this end, the first parabolic mirror (241) is arranged such that its mirror surface faces rearward but is inclined at approximately 45 degrees with respect to the horizontal plane, thereby upwardly collimating a horizontal diverging beam directed forward from the rear emitter.

The second parabolic mirror (242) disposed above the first parabolic mirror focuses the terahertz waves (TB1, arrow) upwardly collimated by the first parabolic mirror (241) onto a sample (not shown) in front.

The terahertz waves (TB2, arrow) reflected by the sample are transmitted to the detector by the sample reflection optical system (third and fourth parabolic mirrors).

The sample reflection optical system including the third and fourth parabolic mirrors (243, 244) is arranged at the other side inside the mirror block, in front of the detector mounting part. The third parabolic mirror (243) is fixed to the upper part of the mirror block (200), and the fourth parabolic mirror (244) fixed to the lower part of the mirror block is disposed to face the lower side of the third parabolic mirror.

The third parabolic mirror (243) is fixed to the upper part of the mirror block adjacent to the second parabolic mirror, and its mirror surface is arranged such that terahertz waves irradiated by the second parabolic mirror and reflected from the sample are reflected by the mirror surface of the third parabolic mirror (243) and downwardly collimated. The fourth parabolic mirror fixed to the lower part of the mirror block has its mirror surface arranged to focus the downwardly collimated terahertz waves rearward to be transmitted to the detector. More specifically, the fourth parabolic mirror (244) is arranged at one side inside the mirror block so as to be aligned with the detector. The fourth parabolic mirror (244) is arranged such that its mirror surface faces the rear detector but is inclined at approximately 45 degrees with respect to the horizontal plane.

This arrangement of the first to fourth parabolic mirrors requires only a narrow space within the mirror block, thus allowing for the implementation of a sufficiently miniaturized reflection optical system.

The first to fourth parabolic mirrors are adjacent to each other, but the angle and arrangement of the mirror surface of each mirror are fixed to the mirror block at a pre-set angle in consideration of a single focused spot and the incident light path of the reflected beam. Fine adjustment is made by adjusting the position of the emitter mounting part and the detector mounting part, which will be described later.

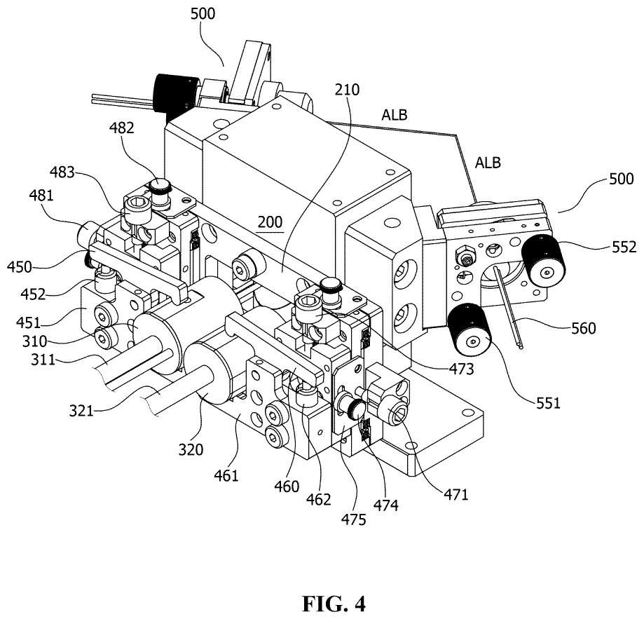

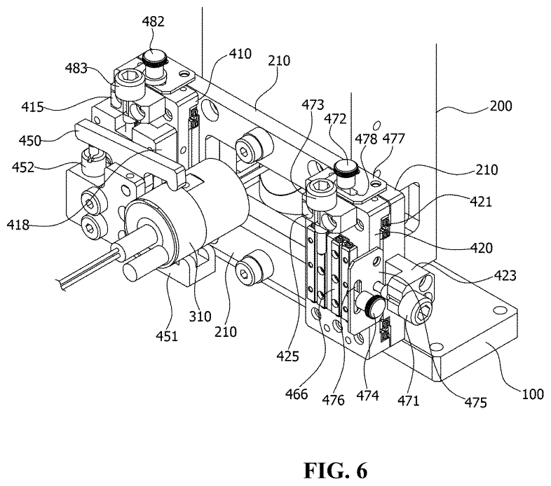

Hereinafter, the configuration of the emitter mounting part, the detector mounting part, and the first and second transfer units will be described in detail with reference to FIGS. 4 to 6.

According to FIG. 4, the emitter mounting part includes an emitter holder (451) supporting and receiving the emitter, a first pusher (450) hinge-coupled to the emitter holder for fixing the emitter to the emitter holder, and a first spring assembly (452) providing a fixing force to the first pusher.

The detector mounting part includes a detector holder (461) supporting and receiving the detector (320), a second pusher (460) hinge-coupled to the detector holder for fixing the detector to the detector holder, and a second spring assembly (462) providing a fixing force to the second pusher.

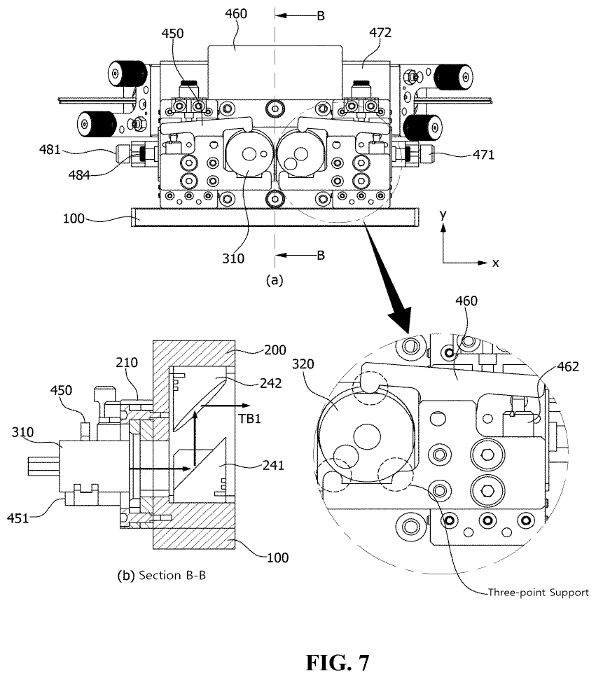

The structures of the emitter mounting part and the first transfer unit, and the detector mounting part and the second transfer unit are identical and symmetrically arranged about the dotted line in FIG. 7. Hereinafter, redundant descriptions of the same structures will be omitted.

The first and second pushers (450, 460), which are hinge-coupled to the emitter/detector holders, are equipped with the first and second spring assemblies (452, 462) consisting of pins and springs. When one end of the pusher is pressed down from above, the end of the pusher on the holder (451, 461) side is lifted by the intermediate hinge, allowing the emitter/detector mounted on the holder to be detached. Also, by moving the detector or emitter in the z-direction (front-rear direction) on the holder, it is possible to adjust the z-axis direction position of the detector or emitter. Referring to FIG. 7, the pushers (450, 460) and the holders (451, 461) can fix the detector (320) or the emitter (310) using a three-point support method.

Meanwhile, a first transfer unit is provided between the emitter holder and the mirror block to connect the emitter holder to the mirror block so as to be movable in the xy-axis direction. A second transfer unit is provided between the detector holder and the mirror block to connect the detector holder to the mirror block so as to be movable in the xy-axis direction. The structure of the transfer unit will be described in detail below.

According to FIGS. 4 to 6, a fixing plate (210) in the form of a hollow open rectangular plate is fastened to the rear surface of the partially open mirror block (200). The fixing plate is coupled with a first transfer unit that connects the emitter mounting part to the mirror block so as to be movable in the xy-axis direction, and a second transfer unit that connects the detector mounting part to the mirror block so as to be movable in the xy-axis direction.

The structures of the first transfer unit and the second transfer unit are the same, but their arrangement directions are symmetrical with respect to the y-axis. Since the structures of the first transfer unit and the second transfer unit are the same, the descriptions below will omit the terms “first” and “second”.

The transfer unit includes an X-axis transfer unit configured to allow translational movement in the X-axis direction with respect to the mirror block and a Y-axis transfer unit configured to allow translational movement in the Y-axis direction.

The X-axis transfer unit includes an X-axis stage (410, 420) movably coupled to the rear of the fixing plate (210) in the X-axis direction, X-axis guides (411, 421) fixed to the fixing plate (210) for guiding the X-axis movement of the X-axis stage (410, 420), and an X-axis fixing part for fixing the X-axis stage (410, 420) to the fixing plate (210). The X-axis fixing part includes an X-axis fixing plate (477) fixed to the upper surface of the fixing plate (210) and having an X-axis elongated hole (478) formed therein, and X-axis fixing screws (482, 472) inserted into the elongated hole (478) for fixing the X-axis stage (410, 420) to the fixing plate (210). By tightening the X-axis fixing screws (482, 472) in the Y-axis direction, the X-axis stage (410, 420) is fixed in position to the fixing plate (210).

The X-axis transfer unit further includes an X-axis adjustment screw (471) that enables fine adjustment of the X-axis direction position of the X-axis stage (410, 420). The X-axis adjustment screw (471) is disposed at the side end of the X-axis stage (410, 420) and can finely move the X-axis stage (410, 420) in the X-axis direction by rotation of the screw. The X-axis adjustment screw (471) is rotatably supported by an X-axis fixing member (423) fixed to the fixing plate (210). The X-axis fixing screw and the X-axis adjustment screw are arranged perpendicular to each other with respect to the X-axis stage.

The method of X-axis position adjustment is to slightly loosen the X-axis fixing screws (482, 472), then rotate the X-axis adjustment screw (471) to move the X-axis stage (410, 420) to adjust the position, and then tighten the X-axis fixing screws (482, 472) to lock it.

The Y-axis transfer unit includes a Y-axis stage (418), a Y-axis guide, a Y-axis fixing part for fixing the Y-axis stage (418) to the X-axis stage (410, 420), and Y-axis adjustment screws (473, 483).

The Y-axis stage (418) is connected to the X-axis stage (410, 420) with a Y-axis guide interposed, which is disposed at the rear of the X-axis stage (410). The Y-axis fixing part includes a Y-axis fixing plate (475) fixed to the side of the X-axis stage (410) and having a Y-axis elongated hole (476) formed therein, and a Y-axis fixing screw (474) inserted into the elongated hole (476) for fixing the Y-axis stage to the X-axis stage. By tightening the Y-axis fixing screw (474), the Y-axis stage is fixed in position to the X-axis stage.

The Y-axis adjustment screw enables fine adjustment of the Y-axis direction position of the Y-axis stage, and although its arrangement direction is different from that of the X-axis adjustment screw (471), its operating principle is the same.

Hereinafter, the arrangement and structure of the visible light laser unit for terahertz wave monitoring will be described with reference to FIGS. 2, 3, and 5.

Since it is difficult to visually confirm terahertz waves, two visible light lasers are focused on the sample to visually check alignment issues.

According to FIG. 2, the visible light laser unit includes a pair of visible light laser units (500) respectively coupled to both side surfaces of the mirror block. The visible light laser units are arranged such that visible light laser beams are irradiated at the focused position of the terahertz waves irradiated through the mirror block.

The visible light laser unit includes fixing members (220) fixed to both side surfaces of the mirror block (200), a laser mounting part (530) coupled to the fixing members (220), laser adjustment screws (551, 552), and a visible light laser (510). In the laser mounting part (530), a leaf spring is interposed between two plates, and the irradiation direction of the visible light laser beam can be finely adjusted using laser adjustment screws (551, 552) arranged diagonally. The visible light laser unit for indicating the irradiation position of terahertz waves can be simultaneously used as excitation light for measuring doping concentration and the like.

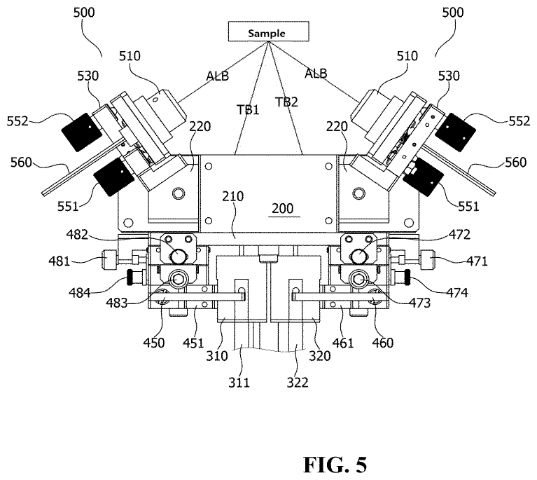

As shown in FIG. 5, a pair of visible light laser beams (ALB) are arranged with an inclination on both side surfaces of the mirror block so that they can meet at the focused position of the terahertz waves. At this time, the sample irradiation optical system and the sample reflection optical system are arranged symmetrically about the focused position in the left-right direction, and the pair of visible light lasers are also arranged symmetrically about the focused position in the left-right direction. The arrangement angle of the pair of visible light lasers is determined in consideration of the focused position (x, y, z) of the terahertz waves. However, fine position control is possible by the laser adjustment screws.

The terahertz wave reflection optical system module according to an embodiment of the present invention further includes a connection plate (100) fixed to the lower or upper part of the mirror block, and the connection plate may have a fastening part for coupling to a robot arm or a translational movement mechanism, that is, a driving unit.

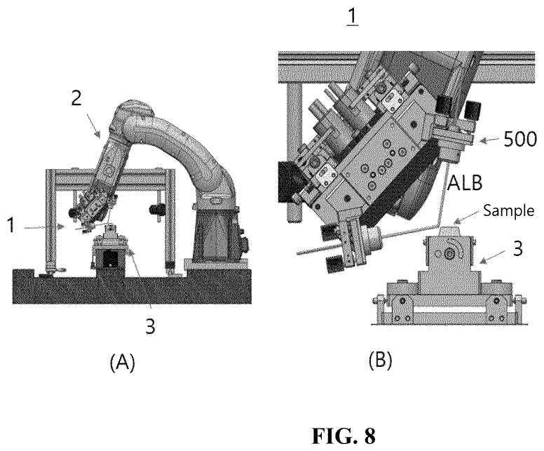

FIG. 8(A) illustrates a robot arm on which the terahertz wave reflection optical system module according to an embodiment of the present invention is mounted, and FIG. 8(B) is an enlarged view of the terahertz wave reflection optical system module, a measurement sample, and a sample stage (3) in FIG. 8(A).

As shown in FIG. 8, the terahertz wave reflection optical system module (1) of the present invention can be easily mounted on a robot arm (2) using the connection plate (100). In the terahertz wave reflection optical system module of the present invention, four mirrors, an emitter, and a detector are stably fixed to a compact reflection optical system module, so that the optical path and alignment can be maintained even by the free movement of the robot arm (2). Furthermore, the emitter mounting part and the first transfer unit, and the detector mounting part and the second transfer unit of the terahertz wave reflection optical system module of the present invention enable easy three-dimensional position control of the emitter and detector, thereby easily adjusting the focused position of the terahertz waves on the sample. Since probe light and pumping light transmitted to the emitter and detector can all be transmitted through optical fibers, the module can be implemented with the minimum necessary components to achieve miniaturization, enabling scanning of complex-shaped samples using a robot arm.

Since it is difficult to visually confirm terahertz waves, two visible light lasers are focused on the sample to visually check alignment issues. A method for setting the visible light laser beams (ALB) to coincide with the focusing position of the terahertz wave beams (TB1, TB2) will be described with reference to FIGS. 2, 5, and 8.

In a state where a sample is affixed to a stationary table or a linearly movable sample stage (3), the focal position of the terahertz wave in the height direction, directed at a target depth (the surface) of the sample, is adjusted. The adjustment method uses the intensity of the signal detected by the detector. That is, since the reflected wave intensity is greatest at the surface, this position is set as the target focusing position, and at this time, the adjustment screws of the pair of visible light lasers are used to focus the visible light laser beams (ALB) to meet on the sample surface.

Meanwhile, to identify a specific spot on the sample plane, that is, the focusing position on the sample surface, the point where the intensity of the signal detected by the detector disappears while moving a terahertz wave-opaque flat plate in the xy direction can be identified as the focusing position.

In this way, while determining the terahertz wave focusing position, the visible light laser beams are simultaneously focused and set at the same position. The pair of visible light laser units are basically arranged to meet at the focused position of the sample irradiation optical system (see FIG. 5). By performing the above process and finely adjusting the positions using the adjustment screws, the focusing positions of the terahertz wave and the visible light laser can be accurately matched.

Through this process, once the focusing positions of the terahertz wave and the visible light laser are matched, and the terahertz wave reflection optical system module (1) of the present invention is coupled to a robot arm or the like, the terahertz wave focusing position can be visually confirmed, and this visible light laser can also be used as excitation light without the need to apply separate excitation light to the sample.

### INDUSTRIAL APPLICABILITY

The terahertz wave reflection optical system of the present invention can be used in various measuring devices including terahertz wave measuring instruments, and thus has industrial applicability.

1. A terahertz wave reflection optical system module for irradiating a sample with terahertz waves and detecting terahertz waves reflected from the sample, comprising:
a mirror block on which a plurality of parabolic mirrors constituting a sample irradiation optical system and a sample reflection optical system are mounted;
an emitter mounting part which is position-adjustably coupled to one side of rear of the mirror block for mounting an emitter; and
a detector mounting part which is position-adjustably coupled to the other side of the rear of the mirror block for mounting a detector.

2. The terahertz wave reflection optical system module of claim 1, wherein:
the mirror block has a rectangular frame shape with front and rear sides open and a space formed therein for mounting the plurality of parabolic mirrors, and the emitter mounting part and the detector mounting part are arranged side by side at the rear of the mirror block;
the sample irradiation optical system including first and second parabolic mirrors is disposed inside the mirror block on one side thereof in alignment with the emitter mounting part, the first parabolic mirror is fixed to the lower portion of the mirror block, and the second parabolic mirror fixed to the upper portion of the mirror block is disposed above and facing the first parabolic mirror;
the sample reflection optical system including third and fourth parabolic mirrors is disposed inside the mirror block on other side thereof in alignment with the detector mounting part, the third parabolic mirror is fixed to the upper part of the mirror block, and the fourth parabolic mirror fixed to the lower part of the mirror block is disposed to face the lower side of the third parabolic mirror;
the sample irradiation optical system is configured such that terahertz waves generated from the emitter and irradiated forward are upwardly collimated by the first parabolic mirror and irradiated to the second parabolic mirror, and the upwardly collimated terahertz waves are focused at a predetermined position in front by the second parabolic mirror; and
the sample reflection optical system is configured such that terahertz waves reflected from the predetermined focused position are irradiated to the third parabolic mirror, downwardly collimated by the third parabolic mirror and irradiated to the fourth parabolic mirror, and focused by the fourth parabolic mirror to be detected by the detector mounted on the detector mounting part.

3. The terahertz wave reflection optical system module of claim 1, wherein:
the mirror block has a space formed therein in which the plurality of parabolic mirrors are mounted;
the sample irradiation optical system includes first and second parabolic mirrors disposed vertically opposite to each other;
the first parabolic mirror secured on one side inside the mirror is fixed to a lower portion of the mirror block in alignment with the emitter to upwardly collimate terahertz waves irradiated forward from the emitter;
the second parabolic mirror, which is mounted to an upper portion of the mirror block, is disposed to focus the upwardly collimated terahertz waves at a predetermined position in front thereof;
the sample reflection optical system includes third and fourth parabolic mirrors disposed vertically;
the third parabolic mirror is fixed to upper portion of the mirror block adjacent to the second parabolic mirror and disposed to downwardly collimate terahertz waves irradiated from the predetermined position; and
the fourth parabolic mirror secured to the lower portion of the mirror block is disposed to focus the downwardly collimated terahertz waves rearward to be transmitted to the detector.

4. The terahertz wave reflection optical system module of claim 1, further comprising:
a first transfer unit configured to connect the emitter mounting part to the mirror block so as to be movable in the xy-axis direction; and
a second transfer unit configured to connect the detector mounting part to the mirror block so as to be movable in the xy-axis direction,
wherein the emitter mounting part includes an emitter holder supporting and receiving the emitter, a first pusher hinge-coupled to the emitter holder for fixing the emitter to the emitter holder, and a first spring assembly providing a fixing force to the first pusher;
wherein the detector mounting part includes a detector holder supporting and receiving the detector, a second pusher hinge-coupled to the detector holder for fixing the detector to the detector holder, and a second spring assembly providing a fixing force to the second pusher; and
wherein the xy-axis direction is the horizontal and vertical direction in the rear surface of the mirror block.

5. The terahertz wave reflection optical system module of claim 4, wherein:
the first transfer unit includes a first X-axis transfer unit configured to allow translational movement in the X-axis direction with respect to the mirror block and a first Y-axis transfer unit configured to allow translational movement in the Y-axis direction;
the first X-axis transfer unit includes a first X-axis fixing screw for fixing the position of the first X-axis transfer unit and a first X-axis adjustment screw for finely adjusting the X-axis direction position of the first X-axis transfer unit;
the first Y-axis transfer unit includes a first Y-axis fixing screw for fixing the first Y-axis transfer unit and a first Y-axis adjustment screw for finely adjusting the Y-axis direction position of the first Y-axis transfer unit;
the second transfer unit includes a second X-axis transfer unit configured to allow translational movement in the X-axis direction with respect to the mirror block and a second Y-axis transfer unit configured to allow translational movement in the Y-axis direction;
the second X-axis transfer unit includes a second X-axis fixing screw for fixing the position of the second X-axis transfer unit and a second X-axis adjustment screw for finely adjusting the X-axis direction position of the second X-axis transfer unit; and
the second Y-axis transfer unit includes a second Y-axis fixing screw for fixing the second Y-axis transfer unit and a second Y-axis adjustment screw for finely adjusting the Y-axis direction position of the second Y-axis transfer unit.

6. The terahertz wave reflection optical system module of claim 1, further comprising:
a connection plate fixed to the lower or upper part of the mirror block,
wherein the connection plate has a fastening part for coupling to a robot arm or a transfer device.

7. The terahertz wave reflection optical system module of claim 1, further comprising:
a visible light laser unit coupled to a side surface of the mirror block,
wherein the visible light laser unit is equipped with an adjustment screw capable of adjusting the attitude of the visible light laser so that a visible light laser beam irradiated from the visible light laser unit coincides with a terahertz wave irradiation position of the sample.

8. The terahertz wave reflection optical system module of claim 1, further comprising:
visible light laser units respectively coupled to both side surfaces of the mirror block,
wherein the visible light laser units irradiate visible light lasers so as to correspond to a focused position of terahertz waves by the sample irradiation optical system, thereby enabling visual monitoring of the terahertz wave irradiation position while irradiating excitation light to the sample.

9. The terahertz wave reflection optical system module of claim 1, wherein:
the sample irradiation optical system and the sample reflection optical system are adjacently arranged side by side within the mirror block;
the sample irradiation optical system is composed of first and second parabolic mirrors mounted to face each other vertically on the upper and lower sides of the mirror block;
the sample reflection optical system is composed of third and fourth parabolic mirrors mounted to face each other vertically on the upper and lower sides of the mirror block;
the sample irradiation optical system implements an optical path in which terahertz waves are vertically collimated from the rear of the mirror block via the first parabolic mirror and focused forward by the second parabolic mirror;
the sample reflection optical system implements an optical path in which terahertz waves are vertically collimated from the front of the mirror block via the third parabolic mirror and focused rearward by the fourth parabolic mirror; and
terahertz waves reflected from the focused position by the sample irradiation optical system are arranged to enter the third parabolic mirror of the sample reflection optical system.

10. The terahertz wave reflection optical system module of claim 9, wherein:
the first parabolic mirror and the fourth parabolic mirror are arranged side by side in the left-right direction and have the same focal length;
the second parabolic mirror and the third parabolic mirror are arranged side by side in the left-right direction and have the same focal length; and
the focal length of the second parabolic mirror is greater than the focal length of the first parabolic mirror.
